(19) United States
(12) Patent Application Publication
(10) Pub. No.: US 2014/0300927 A1
(43) Pub. Date: Oct. 9, 2014

(54) INFORMATION PROCESSING SYSTEM, IMAGE FORMING APPARATUS AND METHOD OF CONTROLLING THE SAME, AND STORAGE MEDIUM

(71) Applicant: CANON KABUSHIKI KAISHA, Tokyo (JP)

(72) Inventor: Shigeki Kuroda, Yokohama-shi (JP)

(21) Appl. No.: 14/208,602

(22) Filed: Mar. 13, 2014

(30) Foreign Application Priority Data
Apr. 9, 2013 (JP) 2013-081661

(51) Int. Cl. H04N 1/00

(52) U.S. Cl. CPC H04N 1/0097; H04N 1/00408
USPC 358/1.15

(57) ABSTRACT

An image forming apparatus reads out setting information corresponding to a state in which a user logs in the image forming apparatus from a storage unit, and displays a screen in accordance with the read out setting information.

### BACKGROUND OF THE INVENTION

1. Field of the Invention

The present invention relates to an information processing system, an image forming apparatus, a method of controlling the same and a storage medium.

2. Description of the Related Art

Conventionally, a resume function is known in which in order to improve the operability of a device, a setting screen, from when a user of the device previously used the device, is stored, and the next time the user uses the device, the stored setting screen is displayed as an initial screen. In such as case, the final operation content when the user used the device, or screen information is stored, and after the device is powered off, or the user logs out, this information is retained. Then, when the user once again uses the device, the previously stored operation content, or the screen information, is called up, the user can resume the processing continuing from the previous operation easily. This resume function has spread as a function for PCs in particular, but similar resume functions are also known for other information processing apparatuses. For example, in Japanese Patent Laid-Open No. 7-93349, a resume function is disclosed for electronic filing.

However, in the conventional method, when final user operation content, or screen information, is stored, the operation content or the screen information is called up the next time the user uses the device. For this reason, in cases where the usage state of the device, or the conditions of the device, when the user once again uses the device are different from conditions when the operation content or the screen information was stored previously, a screen different from the current usage state of the device will be displayed. In such a case, problems such as the user not being able to execute a desired operation from the screen may occur.

In particular, in cases where an image forming apparatus, or the like, has many accessories or option units, there are cases where device information such as usage state and device configuration is different every time the user uses the image forming apparatus. For example, in cases where the image forming apparatus comprises a document copy function, and a saved document print function for printing a saved document, when the user executes the saved document print function and completes the operation, the next time of usage, a saved document printing setting screen is displayed. However, in cases where a user is trying to copy a document, and is placing an original on a document feeder, or the like, there is a problem in that the user cannot perform the desired copy operation from the setting screen for printing the saved document which is displayed upon the resume function.

### SUMMARY OF THE INVENTION

An aspect of the present invention is to eliminate the above-mentioned problems which are found in the conventional technology.

A feature of the present invention is to provide a technique for improving user operability by making a screen displayed in a resume function be a screen corresponding to a current usage apparatus state.

According to an aspect of the present invention, there is provided an image forming apparatus comprising: a storage unit configured to store setting information corresponding to each of a plurality of states of the image forming apparatus; a reading unit configured to read out, from the storage unit, setting information corresponding to a state in which a user logs in the image forming apparatus; and a display unit configured to display a screen in accordance with the setting information read out by the reading unit.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view for showing an overall configuration of an information processing system including a multi function peripheral according to a first embodiment of the present invention.

FIG. 2 is a block diagram for showing a hardware configuration of an MFP and a server of the information processing system according to the first embodiment.

FIG. 3 is a functional block diagram for explaining an MFP program configuration according to the first embodiment.

FIG. 4A depicts a view for showing an example of a screen of a top main menu displayed as an initial screen upon power activation of the MFP.

FIG. 4B depicts a view for illustrating an example of an initial screen of a copy application.

FIG. 5A depicts a view for showing an example of an initial screen of a transmission application.

FIG. 5B depicts a view for showing an example of an initial screen of a scan and save application.

FIG. 6 depicts a view for illustrating an example of a print setting screen of a saving application.

FIG. 7 is a flowchart for describing a resume function in the MFP according to the first embodiment.

FIG. 8A depicts a view for illustrating an example of a reproduction management table for the embodiment.

FIG. 8B depicts a view for explaining a program configuration in a server according to a second embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

Firstly, explanation will be given for a first embodiment according to the present invention.

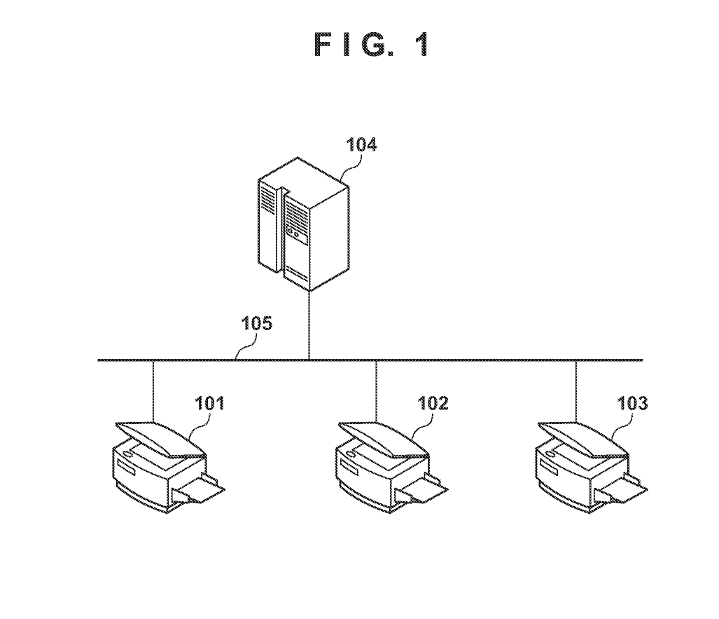

FIG. 1 depicts a view for showing an overall configuration of an information processing system including an image forming apparatus according to a first embodiment of the present invention. In this system, an MFP 101, an MFP 102, and an MFP 103 are included as image forming apparatuses, and these are connected via a LAN (local area network) 105 with a server 104.

Each of the MFPs 101-103 has a scanning function for scanning paper media (an original), a copy function for printing an image onto a sheet based on the image data obtained by the scanning function, and a printing function for printing with PDL data from a PC (not shown). Also, each of the MFPs 101-103 has a scan transmission function for saving the image data obtained by the scanning function, and transmitting to another apparatus as digital data. Furthermore, they are provided with functions for once again printing or transmitting saved image data.

The server 104 is capable of communicating with the plurality of MFPs, and is provided with functions such as an application for managing the plurality of MFPs, or authentication processing. Also, each of the MFPs 101-103 is capable of communicating with each other without going through the server 104. Here, any of the MFP may also have a server function.

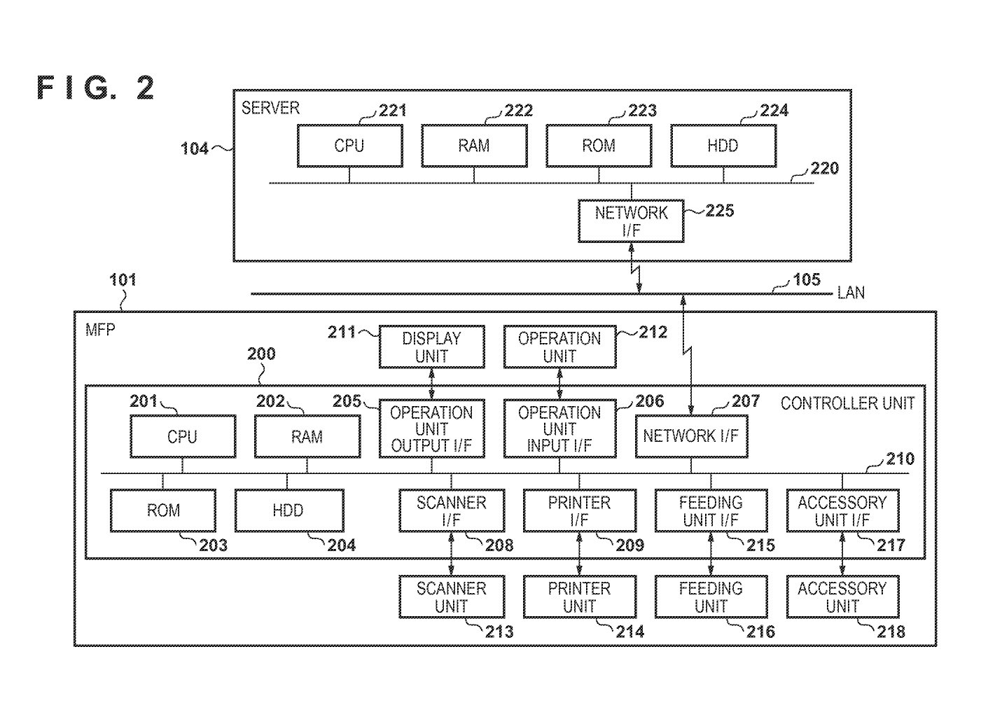

FIG. 2 is a block diagram for showing a hardware configuration of the MFP 101 and the server 104 of the information processing system according to the first embodiment. Note, the MFP 101, the MFP 102 and the MFP 103 all have the same configuration. Also, in the explanation below, explanation will be given as processing in the MFP 101, but the MFPs 102 and 103 are capable of similar processing.

Firstly, explanation will be given for the configuration of the MFP 101. The MFP 101 comprises a scanner unit 213 and a printer unit 214, and is provided with a display unit 211 for displaying messages, and the like, to a user, an operation unit 212 for receiving operations from a user, and a controller unit 200 capable of connecting with the LAN 105. The controller unit 200 comprises a CPU 201 for executing various control programs. The CPU 201 deploys an OS and programs stored in an HDD (hard disk drive) 204 into a RAM 202 based on a boot program stored in a ROM 203 to activate the system. Then, the CPU 201 implements programs deployed in the RAM 202 to execute predetermined processing using the RAM 202 as a work area. Various control programs are installed in the HDD 204. Also, image data output from the scanner unit 213 and data obtained via a network I/F 207 is stored in the HDD 204.

An operation unit output I/F 205 controls data output to the display unit 211. An operation unit input I/F 206 controls data input from the operation unit 212. The network I/F 207 is connected to the LAN 105 and controls input and output of information via the LAN 105. Furthermore, the network I/F 207 performs data transmission control for transmitting scan data stored in the HDD 204 via the LAN 105 to a designated external apparatus, under a control of the CPU 201. A scanner I/F 208, as well as inputting image data from the scanner unit 213, performs input and output of control data for controlling the scanner unit 213. A printer I/F 209, as well as outputting image data to the printer unit 214, performs input and output of control data for controlling the printer unit 214. A feeding unit I/F 215 obtains a state of a feeding unit 216, and controls to obtain such things as a remaining paper amount of the feeding unit 216. An accessory unit I/F 217 controls to obtain an option configuration of an accessory unit 218, and to detect and obtain each accessory state. Each of the units denoted by the above 202-209, 215 and 217 are connected to the CPU 201 via a system bus 210.

The operation unit 212 is provided with an input apparatus such as a touch panel, or hard keys, and comprises a user interface for receiving an instruction input by a user. The display unit 211 is provided with a display apparatus such as a liquid crystal display unit, and an LED, for example, and comprises a user interface for performing various display to the user. The display unit 211 is used for displaying an operation screen such as that for the various copy or the print functions that the MFP 101 has, and an operation screen for performing setting of the MFP 101, and a screen including state information such as a print state.

The scanner unit 213 is provided with an optical image reading apparatus such as a CCD, optically scans paper media, and outputs electronic image data. The printer unit 214 forms a visible image on a printing medium, such as a sheet, based on electronic image data. Image data (scan data) input via the scanner I/F 208 from the scanner unit 213 is stored in the RAM 202 or in the HDD 204. Image processing, and the like, is executed on the stored image data by an application program stored in the RAM 202 as necessary. Also, in cases where the image data is printed with the printer unit 214, similarly, the image data is output to the printer unit 214 via the printer I/F 209.

The feeding unit 216 is provided with a cassette, a paper deck and a feeding apparatus such as a manual feed tray, a remaining paper amount, a paper size, and the like, of each feeding unit are detected, whether or not paper is set is detected, and the CPU 201 is notified of the information via the feeding unit I/F 215. The accessory unit 218 is an accessory apparatus of the MFP 101 such as a document feeder (ADF), or a finisher, and a state of each accessory apparatus is detected, and the CPU 201 is notified via the accessory unit I/F 217. In this information, information of whether or not paper is set in the document feeder (ADF), and information such as the existence or absence of a stapling or a saddle stitch function of a finisher is included.

Next, explanation will be given for a configuration of the server 104 according to the first embodiment.

In the server 104, a CPU 221 executes a boot program stored in a ROM 223, and loads an OS, a program or the like, installed in a HDD 224 into a RAM 222. Then, the CPU 221 performs overall control of each device via an internal bus 220 by executing programs. The RAM 222, the ROM 223, the HDD (hard disk drive apparatus) 224, the network interface 225, and the like are connected to the internal bus 220. A network interface 225 performs bidirectional data exchange, via the LAN 105, with the MFPs 101-103, various network devices, or a personal computer (PC). The HDD 224 functions as an external storage apparatus, and provides a data storage area for storing information relating to an application for managing a plurality of MFPs.

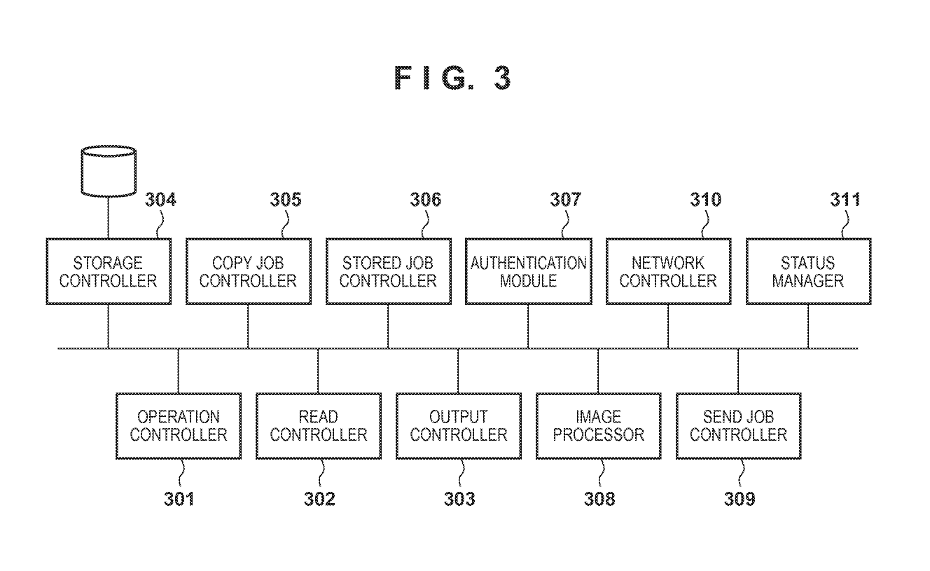

FIG. 3 is a functional block diagram for explaining the MFP 101 program configuration according to the first embodiment. In the explanation below, a program for controlling the MFP 101, which oversees the processing units in FIG. 3, operates under the control of the CPU 201. Accordingly, the functions shown in FIG. 3 are realized by the CPU 201 executing this program.

Firstly, explanation will be given for printing by copying.

The scanner unit 213 functions in coordination with a pressing plate of the accessory unit 218, the document feeder apparatus (ADF), or the like. When the user places an original on an original platen or an ADF, and presses an original scanning initiation button (not shown) of the operation unit 212, the scanner unit 213 optically scans the original on the original platen, or fed to the original platen from the ADF. In a case where multiple pages of originals are scanned, the user performs the scanning by replacing the original on the original platen, or in the case of an ADF, scanning is performed by the originals set on the ADF being sequentially fed. Here, the user can perform print setting via the operation unit 212, such as a setting of a finisher for stapling, or an imposition for the paper, or the like, or an image quality setting such as for density. Also information as to whether or not there is an original in the ADF can be obtained via the accessory unit I/F 217.

An operation controller 301 displays screens and information necessary for operation on the display unit 211, receives information of user operation performed on the operation unit 212, and determines what kind of operation is instructed. Also, when the user requests printing by copying, the operation controller 301 makes an instruction so that the screen information necessary for copying is generated and displayed on the display unit 211. The user sets an original on the original platen or the ADF and makes an instruction to copy because a screen for copying is displayed on the display unit 211. Here, the user simultaneously may perform the previously described print setting instruction through this screen. The instruction to copy is passed from the operation unit 212 to the operation controller 301 via the operation unit I/F 206. The operation controller 301, having received the copy instruction, transitions the control to a copy job controller 305.

The copy job controller 305 first makes an instruction for scanning of the original to a read controller 302 because scanning of the original is necessary. With this, the read controller 302 scans the original by controlling the scanner unit 213 via the scanner I/F 208. Note, in cases where the original on the original platen is replaced, the control is returned from the copy job controller 305 to the operation controller 301, and once again, a selection screen is displayed on the display unit 211 for the selection of whether to perform scanning of the next original or whether to initiate printing. Image data obtained by the scanner unit 213 in this way is stored in the RAM 202 or the HDD 204 by a storage controller 304 via the scanner I/F 208 or the system bus 210. Note, the read controller 302 determines whether the data is stored in the RAM 202 or the HDD 204 based on the size of the image data and whether or not high speed processing is requested, for example.

Next, the copy job controller 305 makes an instruction for printing of the image data stored by the control of the storage controller 304 to an output controller 303 because printing of the scanned image data is necessary. The output controller 303 makes an instruction to an image processor 308 so that image processing be applied with the print settings that the user specified to the image data stored in the RAM 202 or the HDD 204 by the storage controller 304. This image processing may be, for example, editing of the image data such as imposing so that two originals are put onto one sheet (2-in-1), or the like. When the editing of the image data for the printing completes, the image processor 308 stores the post-editing image data into the RAM 202, the HDD 204, or the like, under the control of the storage controller 304. The output controller 303 reads out image data which is the result of the image processing being applied from the RAM 202 or the HDD 204 with the storage controller 304, and outputs the image data via the system bus 210 and the printer I/F 209 to the printer unit 214. With this, the printer unit 214 prints an image on the sheets sequentially based on the sent image data.

Next, explanation will be given for an authentication module 307 which executes authentication.

In cases where the user uses the MFP 101, an authentication of the user can be performed. This may be, for example, displaying a screen on the display unit 211 to allow the user to input a user name and a password, and those being input by the user. When the user inputs the necessary information via this screen, the user name and the password that are input are sent to the authentication module 307 via the operation unit input I/F 206. The authentication module 307 performs the authentication of the user by checking whether there is a matching user name and password in a user database stored in a storage unit, for example, the HDD 204, of the MFP 101. This authentication processing is not limited to the method explained in this embodiment, and some other authentication method using a non-contact type IC card, for example, is also possible. Furthermore, rather than holding authentication information locally, embodiments in which the authenticating is performed by an external authentication server such as Active Directory, for example, may be used. In such a case, the authentication module 307 makes a query to the external authentication server.

Next, explanation will be given for a stored job controller 306.

The stored job controller 306 controls an application using a storage file. When the user dispatches a request for a print using a storage file, the operation controller 301 makes an instruction so that screen information necessary for the printing of the storage file is generated, and displayed on the display unit 211. Because a screen for printing using a storage file is displayed on the display unit 211, the user makes an instruction for printing by selecting the saved file on the screen. Here, the print instruction using the storage file is passed to the operation controller 301 via the operation unit I/F 206 from the operation unit 212. Because there is an instruction using a storage file, the operation controller 301 transitions the control to the stored job controller 306.

Because data of the saved file is output, the stored job controller 306, under the control of the storage controller 304, makes an instruction to the output controller 303 to print the stored file. The output controller 303 makes an instruction to the image processor 308 so that image processing is applied with the print settings that the user specified for the image data stored in the RAM 202 or the HDD 204 by the storage controller 304. When an image editing by the image processor 308 for the printing completes, the image processor 308 stores the post-editing image data as print data in the RAM 202 with the storage controller 304. The output controller 303 reads out the image data to which the image processing is applied with the storage controller 304 from the RAM 202, and outputs to the printer unit 214 via the system bus 210, and the printer I/F 209. Then, the printer unit 214 prints on the sheet sequentially based on this data.

Next, explanation will be given for a send job controller 309 and a network controller 310. The send job controller 309 controls an application for transmitting image data obtained by the scanner unit 213.

When the user requests for a document transmission with a “scan and transmit” application, the operation controller 301 makes an instruction so that screen information necessary for scan transmission is generated and displayed on the display unit 211. Here, the user makes an instruction for the scan transmission by specifying a transmission destination because the screen for scan transmission is displayed on the display unit 211. An instruction of this scan transmission is passed to the operation controller 301 via the operation unit I/F 206 from the operation unit 212. The operation controller 301 transitions the control to the send job controller 309 because it is a scan transmission. The send job controller 309 first makes an instruction for the scanning of an original to the read controller 302 because it is necessary to scan the original. With this, the read controller 302 scans the original by controlling the scanner unit 213 via the scanner I/F 208. Image data obtained in this way is stored temporarily in the RAM 202 or the HDD 204 by the storage controller 304 via the scanner I/F 208 or the system bus 210. Next, the send job controller 309 obtains the image data by making an instruction for reading out the image data to the storage controller 304 in order to transmit the image data. After that, an instruction is made to the network controller 310 so that the image data is transmitted to the specified destination. In the network controller 310, the indicated image data is transmitted to an address of the designated destination via the network I/F 207.

Next, explanation will be given for a state manager 311.

The state manager 311 obtains and manages information such as a device state of the MFP 101, and how the device is being used. Specifically, the state manager 311 detects states such as whether or not the original is set in a document feeder (ADF), and whether or not a sheet is set in a manual feed tray. Also, the state manager 311 obtains and manages information of the accessory unit 218 as a function that the device is able to use. Information of the accessory unit 218 includes information of whether or not a finisher function (for example, stapling, saddle stitching, punching, etc.) is useable. Furthermore, state information such as whether or not a color print is possible, and whether or not various basic functions (copying, scanning, transmitting, saving, etc.) are useable is managed as a function that a device main unit is able to use. If this information is information of a feeding unit, the state manager 311 obtains it via the feeding unit I/F 215 by the feeding unit 216. Also, if the information is information relating to the accessory unit 218, the state manager 311 obtains it via the accessory unit I/F 217. The information that the state manager 311 obtains is stored in the RAM 202 or the HDD 204 by the storage controller 304 as appropriate. Also, the information can be obtained by reading it out from the RAM 202 or the HDD 204 as necessary. Furthermore, the state manager 311 controls an operation screen in coordination with the operation controller 301. For example, configuration can be taken so that in cases where the user wishes to execute a function but that function cannot be used, the corresponding function is masked (deleted) from the operation screen menu, or so that the user can be notified of the fact that the function cannot be used by advising with a message. In such cases, the operation controller 301 controls the operation screen by obtaining function information with the state manager 311. Also, the operation controller 301 is able to save and to call up a state of the operation screen with the storage controller 304 by the information obtained with the state manager 311.

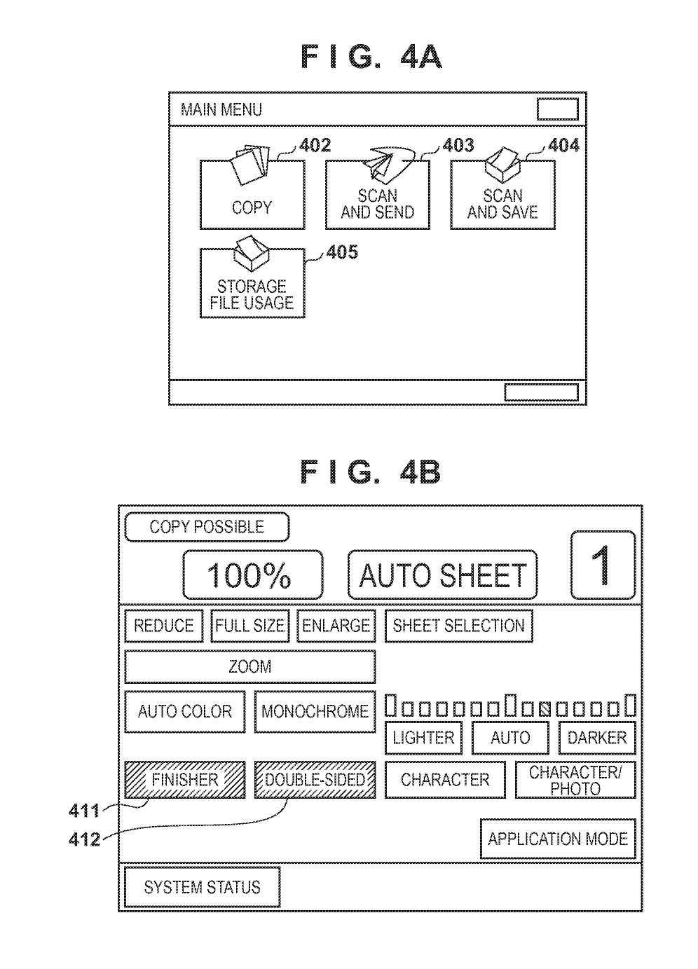

Next, explanation will be given for content displayed on the display unit 211 of the MFP 101 with reference to FIG. 4A-FIG. 6.

FIG. 4A depicts a view for showing an example of a screen of a top main menu displayed as an initial screen upon power activation of the MFP 101.

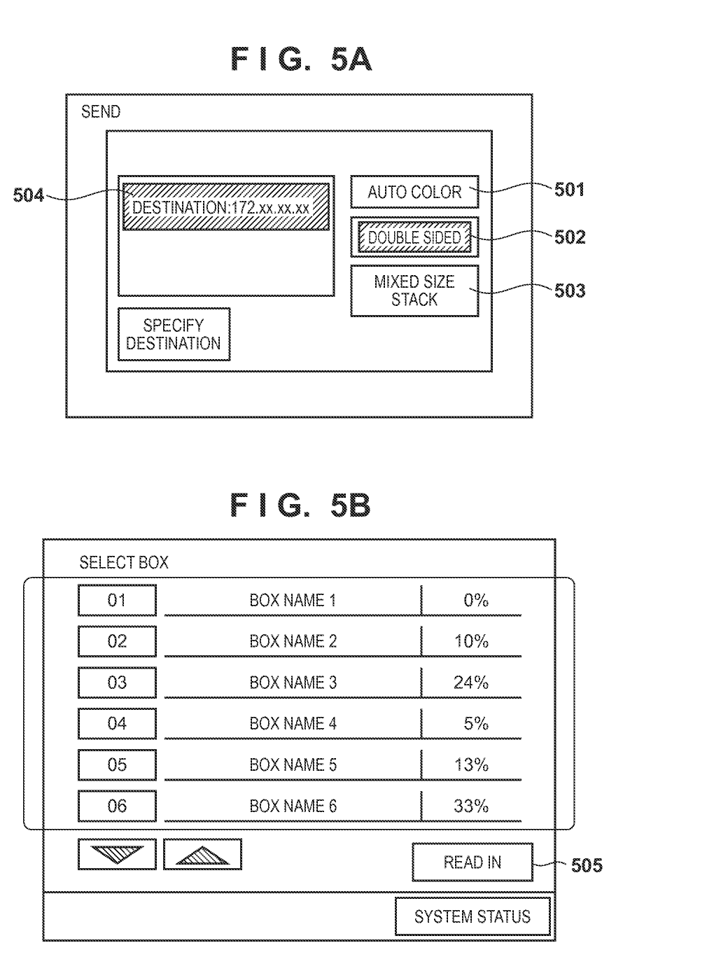

A copy application key 402 is a key for selecting to copy, and when this key is selected, transitioning to a copy screen (for example, FIG. 4B) is made. A send application key 403 is a key for instructing “scan and transmit” so as to scan an original with the scanner unit 213, and to transmit it, and when this key is selected, transitioning to a transmission screen (for example, FIG. 5A) is made. This transmission application is an application for transmitting, by electronic mail, image data input via the scanner I/F 208 from the scanner unit 213 of the MFP 101, and transmitting to a file server. A storage application key 404 is a key for instructing “scan and save” so as to scan an original with the scanner unit 213, and save the image data, and when this key 404 is selected, transitioning to a save screen (for example, FIG. 5B) is made. A saving application is an application for storing image data input via the scanner I/F 208 from the scanner unit 213 of the MFP 101 with the storage controller 304 of the MFP 101 along with information by which identification is possible into the HDD 204. Regarding a storage file use application key 405, when this key 405 is selected, transitioning to a storage file usage screen (for example, FIG. 5B) is made. Storage file usage is an application for selecting image data stored in the HDD 204, along with the previously described information by which identification is possible, and printing or transmitting. The storage file usage application is controlled by the previously described stored job controller 306.

FIG. 4B depicts a view for illustrating an example of an initial screen of a copy application.

The user, via this screen, can perform settings relating to printing, such as settings of the finisher such as stapling and imposition for the sheet, and image quality settings such as printing density, and the like. In this screen example, the keys that are set are represented by an inverted display. A finisher key 411 is pressed in cases of setting a sorting or a stapling mode. A double-sided key 412 is pressed in cases of setting a double-sided print mode. In this screen example the double-sided mode and the finisher mode are set. Note, explanation is omitted for each mode having no direct relation to the embodiment.

FIG. 5A depicts a view for showing an example of an initial screen of a transmission application.

The user, through this screen, can perform setting of a destination or setting upon the scanning of an original. In this screen example, the following modes can be set as the settings for the scanning of the original. There exists an auto-color mode 501 in which an original is scanned automatically distinguishing whether it is a color original, or a monochrome original upon the original scanning, a double-sided mode 502 for original scanning, and a mixed size stack mode 503 which the user specifies in cases where sizes of originals are different. In this screen example, the double-sided mode 502 is set, and the destination 504 of the file server is selected as the destination. In this embodiment, explanation is omitted for modes with no direct relation.

FIG. 5B depicts a view for showing an example of an initial screen of the scan and save application.

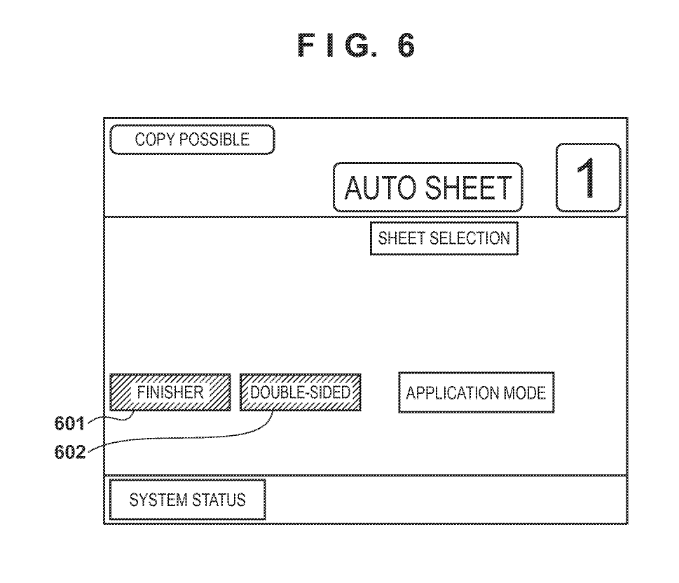

The user selects a data saving destination called a box on this screen. When a read in key 505 is pressed in a case where an original is scanned and saved to a box, after selecting the box, change to a saving setting screen (not shown) is made. Also, in cases where storage file printing is performed in the storage file usage application using the storage file use application key 405, after similarly selecting the box, a printing target file is selected from out of files saved in that box, and print settings are performed on the print setting screen (for example, FIG. 6).

FIG. 6 depicts a view for illustrating an example of a print setting screen of a saving application.

In this screen, the user can perform settings relating to printing, such as settings of the finisher such as stapling and imposition for the sheet, and image quality settings such as printing density, and the like. In this screen example, the keys for which the settings are applied are represented by an inverted display. A finisher key 601 is specified in cases of setting a sorting or a stapling mode. In this screen example, the finisher mode is represented as set. A double-sided key 602 is specified in cases of setting a double-sided print mode. In this screen example, the double-sided print mode is represented as set.

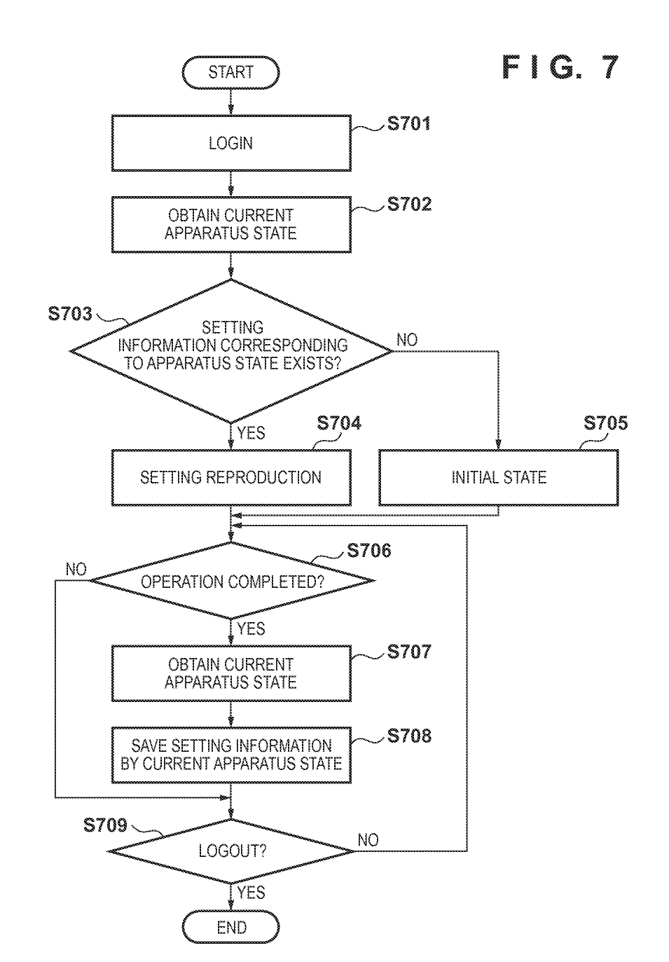

FIG. 7 is a flowchart for describing a resume function in the MFP 101 according to the first embodiment. Note, this processing is realized by a program for executing this processing being loaded into the RAM 202 from the HDD 204, and this program being executed under the control of the CPU 201.

Firstly, in step S701, the CPU 201 executes a login in accordance with a login operation by the user in order to use the MFP 101. Here, the login is the authentication processing explained with the previously described FIG. 3, and is controlled by the authentication module 307. Next, in step S702, the CPU 201 obtains a current apparatus state of the MFP 101. Specifically, conditions such as whether or not an original is placed in a document feeder, and whether or not a manual feed tray is designated as the feeding unit are obtained. This operation is controlled and managed by the previously described state manager 311.

Next, the processing proceeds to step S703, the CPU 201 determines whether or not setting information (screen information) corresponding to a setting state of the current apparatus is registered to the HDD 204. Specifically, the operation controller 301 determines whether setting information corresponding to a device state is stored in the HDD 204 by obtaining information of the device state with the state manager 311 using the storage controller 304. Note, here, it may be determined whether setting information corresponding to the device state is stored, which is setting information related to a user, by referencing an ID of the user that logged in. In a case where, in step S703, the CPU 201 determines that setting information corresponding to the device state is stored, the processing proceeds to step S704, and the CPU 201 displays a screen to the display unit 211 based on the setting information.

On the other hand, in a case where, in step S703, the CPU 201 determines that setting information corresponding to the current apparatus state is not stored, the processing proceeds to step S705, and the CPU 201 displays an initial state screen on the display unit 211. Here, the initial state screen is, for example, a main menu screen as shown in FIG. 4A. Note, the processing of step S704, and step S705, is executed by the operation controller 301, to explain using FIG. 3.

When step S704 or step S705 is executed, the processing proceeds to step S706, and the CPU 201 waits for an operation by the user to be received, and that operation to complete. Here, the completion of the operation indicates an operation for executing a copy job, a save job, a transmission job or a print job completing. To explain specifically, the operation controller 301 determines whether or not an instruction of a user input via the operation unit 212, is an execution instruction of a job due to an initiation button, for example, being pressed. The operation controller 301 displays an execution screen of any one of the copy job controller 305, the stored job controller 306, and the send job controller 309, in accordance with the content of the instructed job, if the instruction of the user is a job execution instruction, and the processing proceeds to step S707. On the other hand, when the operation of the user has yet to be completed in step S706, the processing proceeds to step S709, and the completion of the operations is awaited.

When the CPU 201 determines, in step S706, that the operation of the user completed, and an initiation button of the operation unit 212 is pressed, for example, the processing proceeds to step S707. Because, in step S707, various settings are completed via the operation screen by the user, the operation screen displayed until that point has served its purpose. Accordingly, in step S707, the current apparatus state of the MFP 101 is obtained as well as in the step S702. Next, the processing proceeds to step S708, and the CPU 201, in order to make the operation screen displayed before initiating execution of the job in step S706 into a reproduction screen for the next time, information of the reproduction screen is saved into a later explained reproduction management table in association with the state of the MFP 101 obtained in step S707. Next, in step S709, the CPU 201 receives an operation by the user and determines whether or not the operation is a logout instruction. In a case where it is determined, in step S709, that the operation of the user is not a logout, once again, the processing proceeds to step S706, and in a case where it is determined, in step S709, that it is a logout, the processing completes.

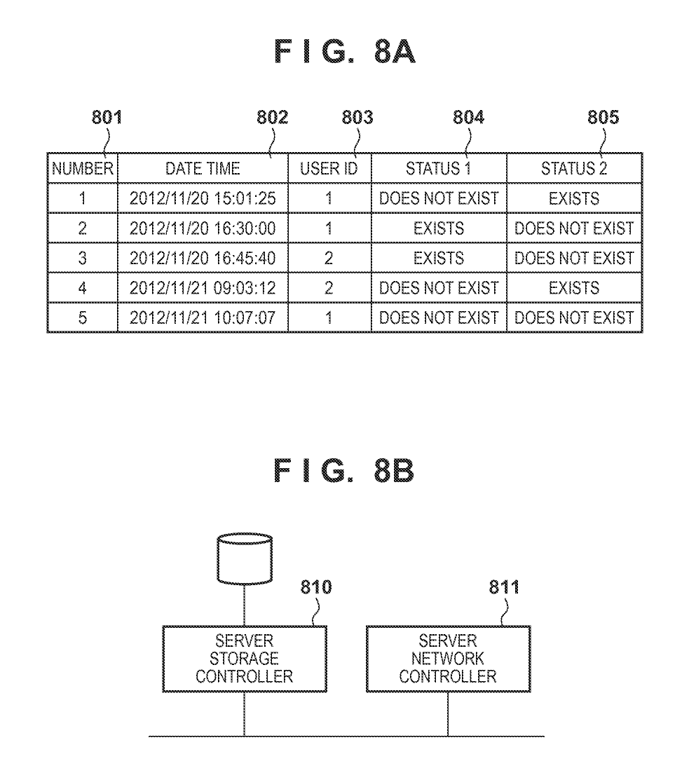

FIG. 8A depicts a view for illustrating an example of a reproduction management table according to the first embodiment. Further detailed explanation will be given of the processing of FIG. 7 using the reproduction management table.

The reproduction management table is saved in a memory (the RAM 202 or the HDD 204) in the previously described step S708, is referenced when determining whether or not there is setting information in step S703, and is saved in the HDD 204 by the storage controller 304 with an instruction of the operation controller 301.

The reproduction management table includes a unique number 801 added consecutively for referencing an item of the table, a date time 802 when the item is saved, a user ID 803 when the setting information is saved, a state 1 (804) and a state 2 (805) which are states for indicating device and operation states, and the like. The number 801 is used as an ID (identifier information) for referencing the reproduction screen saved in step S708 when the user completes the operation in step S706 of the previously described FIG. 7. In other words, because the screen information for reproducing a screen is actually saved by the storage controller 304, this reproduction management table ID and the screen information are managed in association. The operation controller 301 is able to read out screen information in which the setting information is displayed with the storage controller 304, by referencing the number 801 of the reproduction management table.

For example, referring to the setting information of number “1” in FIG. 8A, for example, the date and the time are recorded in the date time 802 for when the item was saved in step S708 of the previously described FIG. 7. Also, from the user ID of the user, it can be seen that the user that stored this item has user ID “1”. The user ID may be a login ID of the user who logged in step S701 of the previously described FIG. 7. Furthermore, setting information for number “1” is “does not exist” for the state 1 and “exists” for the state 2 of the device when the setting information of the number “1” is saved. Note, definitions of states of the device are not limited to those of this embodiment. For example, the state 1 may be defined to be a state representing whether or not there is an original in an auto-feeder. Here, in cases where the state 1 is “exists”, it is showing that there is an original in the auto-feeder in the setting information saved for the number “1”. Also, the state 2 may be defined as a state of whether or not a manual feed tray is used as a feeding unit. Accordingly, in cases where, for example, the state 2 is “exists”, it is showing that a manual feed tray is used as a feeding unit.

Alternatively, it may be defined whether or not there are stapling, punching or saddle stitch functions as accessory information of a device such as a finisher, as the state 1 and the state 2 of the reproduction management table. Also, definition of a state such as whether or not color printing is possible as a function of the device itself is possible.

Next, explanation will be given for another example relating to the reproduction management table.

In the reproduction management table, for the user ID “1”, setting information is registered for the numbers “1”, “2” and “5”. In the setting information of the number “1”, in the state 1 it is recorded that there is no original in the auto-feeder, for example, and in the state 2, it is recorded that there is manual insert usage. Note, in FIG. 8A, screen information for when a copy job is performed is saved in association with the setting information of the number “1”.

Furthermore, in the setting information of the number “2”, in the state 1 it is recorded that there is no original in the auto-feeder, for example, and in the state 2, it is recorded that there is no manual feed tray usage. The screen information for when a copy job is performed is saved in association with the setting information of the number “2” similarly to the number “1”.

Similarly, in the setting information of the number “5”, in the state 1 it is recorded that there is no original in the auto-feeder, for example, and in the state 2, it is recorded that there is no manual feed tray usage. Screen information for when the printing of the saved document is performed is saved in association with the setting information of the number “5”.

It is assumed that in step S702 of the previously described FIG. 7, the user having the user ID “1” has placed an original on the auto-feeder. In such a case, in step S703, corresponding setting information for which the state 1 is “exists”, i.e. there is an original in the auto-feeder, is searched in the reproduction management table shown in FIG. 8A with the latest date time being given preference. In the example of FIG. 8A, in cases where the user ID is “1”, the setting information of the latest date time is the setting information of the number “5”. However, in the setting information of the number “5”, the state 1 is “does not exist”, i.e. there is no auto-feeder, and so the state of the apparatus in step S702 does not match. Accordingly, the setting information of the next newest, the number “2”, is referenced. In the setting information of the number “2”, the state 1 is “exists”, i.e. because it is recorded that there is an original in the auto-feeder, the setting information is extracted as setting information matching the apparatus state obtained in step S702.

In this way, a reproduction screen when the user placed an original in an auto-feeder is not the setting information for when printing of the saved document having the number “5”, which is the latest date time, was performed, but rather is the setting information for when the copy job was performed, where the original was placed in the auto-feeder, having the number “2”, which is the next newest.

Here, explanation was given for an example of the state 1, but searching for setting information matching only the state 2 or both the state 1 and the state 2 is possible. Also, there is no limitation to the example states explained here, and it is possible to manage multiple states.

Also, the number of information items for which it is possible to save to the reproduction management table, and the number of user IDs of users, or a total number may be determined beforehand. In such a case, when the table becomes full, it is possible to discard an old item and save the latest item. Furthermore, when saving, updating to the latest setting information conforming to each state, such as the state 1 and the state 2, may be performed as needed. In such cases, only one setting information item reproduced in accordance with each state will be saved for each state.

Also, as explained with FIG. 4A-FIG. 6 in the first embodiment, the MFP 101 has a plurality of applications. Also, here, explanation has been given with an example for realizing a resume function by reproducing by storing a plurality of the setting states in association with the device state straddling a plurality of applications. However, in a device having a plurality of these kinds of applications, a resume function can also be realized by specifying the application that executed the job. In such a case, a type of the application the user operated is added as an item to the previously described reproduction management table, the content of this is saved, and by referencing it, a resume function that limits the application can also be realized.

By the first embodiment, as explained above, when the user uses the device, based on a state of the device, and device conditions, a screen having similar conditions to that which the user used previously can be realized. Because of this, there is the effect that, upon activation of the apparatus, or login, for example, a screen that the user does not intend to be reproduced is no longer reproduced, and a resume function can be provided in which the user can perform desired operation through the screen that is displayed.

### Second Embodiment

Next, explanation will be given for the second embodiment of the present invention. Note, because the system configuration and the configuration of the MFPs according to the second embodiment are the similar to those of the previously described first embodiment, explanation will be given for only the portions that are differences with the first embodiment.

In the second embodiment, a resume function is executed by managing and saving the reproduction management table and the reproduction screens in the previously described first embodiment on the server 104. In other words, in the first embodiment, explanation was given for managing the reproduction management table on the MFP 101, within an individual MFP, and realizing the resume function within each device, but the reproduction management table may be managed on the external server 104. So, in the second embodiment, explanation will be given for an example in which the resume function is realized in coordination with the external server 104.

FIG. 8B depicts a view for explaining a program configuration in the server 104 in cases where the reproduction management table and the setting information are managed on the server 104 according to the second embodiment.

A server storage controller 810 performs processing equivalent to the saving and calling up, which are a part of the functions of the previously described storage controller 304. A server network controller 811 performs processing such as device state obtaining and notification from each connected MFP via the network interface 225. Programs that realize the server storage controller 810 and the server network controller 811 are installed in the HDD 224, and loaded into the RAM 222 upon execution, and by the CPU 221 executing these programs, the functions are realized. Also, in this case, the reproduction management table, the setting information and the screen information are saved in, and referenced from, the HDD 224 by the server storage controller 701.

In this kind of a configuration, because the reproduction management table is managed and referenced on the server 104, the reproduction management tables and the setting information of the connected MFP, for example, the MFPs 101-103, can be managed in consolidation on the server 104. Then, when the operation controller 301 of the MFP, for example, saves and references the reproduction management table, or the setting information, a request is made to the server 104, via the network I/F 207, using the network controller 310. Here, when the network controller 310 requests to the external server 104 for the saving or referencing of the reproduction management table or the setting information, the server network controller 811 of the server 104 receives the request. Then, the server network controller 811, in response to the request, performs the saving or referencing of the reproduction management table or the setting information using the server storage controller 810.

In this way, when the reproduction management table is managed on the server 104, in addition to the items shown in FIG. 8A, identifier information of the MFP indicating which MFP executes the operation may be added to the reproduction management table. In such a case, when the operation controller 301 of each of the MFPs saves to the reproduction management table, the operation controller 301 performs the saving request attaching its own MFP identifier information. Then, it becomes possible for the operation controller 301 of each of the MFPs to obtain setting information related to its own MFP.

Also, in cases where the MFPs realize a resume function in coordination with the server 104, accessory information of the MFPs is often different. Also, often it occurs that there is a difference amongst the MFPs as to whether or not they have a color printing function. In such a case, it is more effective to record the existence or non-existence of each finisher accessory such as a stapler, a saddle stitching, a punch, or the like, as state information, such as the state 1 and the state 2, which records a state of the reproduction management table. Also, the “existence/non-existence” of a color printing function, and “existence/non-existence” of a transmission function and a saved document print function may be described.

Here explanation will be given for one example. For example, assume that the MFPs 101-103 are managed by the server 104, and the reproduction management tables are not managed by each MFP. Here, the MFP 101 is provided with the color printing function, but the MFP 102 and the MFP 103 are not provided with the color printing function. Here, the user performs a copy printing on the MFP 102, and next performs a copy printing using the color printing function of the MFP 101. With this, the information of the copy printing using the color printing function of the MFP 101 as the setting information is saved in the reproduction management table as the setting information of the user.

Next, in a case where the user tries to copy using the MFP 103, which has no color printing function, the latest setting information of the user is the setting information of the MFP 101 which does have the color printing function. For this reason, the apparatus state does not match regarding color printing on the MFP 101 and the MFP 103. In such a case, the copy printing on the MFP 102 having the same apparatus state as the MFP 103, which was operated before the MFP 101, is selected as the setting information, and the copy screen is reproduced in monochrome.

By the second embodiment, as explained above, the server is able to manage and save the reproduction management table and the reproduction screen, and control the resume function on each of MFPs.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-081661, filed Apr. 9, 2013, which is hereby incorporated by reference herein in its entirety.

What is claimed is:

1. An image forming apparatus comprising:
a storage unit configured to store setting information corresponding to each of a plurality of states of the image forming apparatus;
a reading unit configured to read out, from the storage unit, setting information corresponding to a state in which a user logs in the image forming apparatus; and
a display unit configured to display a screen in accordance with the setting information read out by the reading unit.

2. The image forming apparatus according to claim 1, wherein the setting information includes identifier information of the user, and
the reading unit further reads out, from the storage unit, the setting information, which includes identifier information matching the identifier information of the user of the image forming apparatus.

3. The image forming apparatus according to claim 1, wherein the setting information includes a date time when the setting information was registered, and
the reading unit preferentially reads out the setting information with the latest date time.

4. The image forming apparatus according to claim 2, wherein the reading unit reads out the setting information, which includes identifier information matching the identifier information of a user, from the storage unit when the user logs in to the image forming apparatus.

5. The image forming apparatus according to claim 1, wherein the storage unit further stores screen information associated with the setting information, and
the display unit displays the screen using screen information associated with the setting information read out by the reading unit.

6. The image forming apparatus according to claim 1, wherein the apparatus state includes a state of whether or not an original is placed on a document feeder.

7. The image forming apparatus according to claim 1, wherein the apparatus state includes a state of whether or not a sheet is placed on a manual insert feeding unit.

8. The image forming apparatus according to claim 1, wherein the apparatus state includes a state of whether or not there is a function for a finisher including at least one of stapling, saddle stitching and punching.

9. The image forming apparatus according to claim 1, wherein the apparatus state includes a state of whether or not there is a color printing function.

10. The image forming apparatus according to claim 1, wherein the storage unit, when a display of a screen corresponding to the setting information ends, stores setting information corresponding to the apparatus state obtained by the obtaining unit.

11. The image forming apparatus according to claim 1, wherein the storage unit stores, in association with the setting information, information for identifying an application that was executing when the obtaining unit obtains the apparatus state, and
the reading unit reads out the setting information corresponding to the application that was executing upon use.

12. An information processing system including a server and an image forming apparatus, wherein
the server comprises:
a storage unit configured to store, in association with the image forming apparatus, setting information corresponding to each of a plurality of states of the image forming apparatus;
a reading unit configured to read out from the storage unit, setting information corresponding to a state in which a user logs in the image forming apparatus; and
a transmission unit configured to transmit to the image forming apparatus the setting information read out by the reading unit,
and wherein the image forming apparatus comprises:
a notification unit configured to obtain an apparatus state and notify the server of the apparatus state;
a request unit configured to make a request to the server for the setting information corresponding to the state upon a login of the user; and
a display unit configured to display, a screen corresponding to the setting information, which is transmitted from the server in response to the request by the requesting unit.

13. A method of controlling an image forming apparatus operable to take a plurality of apparatus states, the method comprising:
storing, into a memory, setting information corresponding to each of a plurality of states of the image forming apparatus;
reading out, from the memory, setting information corresponding to a state in which a user logs in the image forming apparatus;
displaying, to a display unit, a screen in accordance with the setting information read out in the reading step.

14. A non-transitory computer-readable storage medium storing a program for causing a computer to function as the image forming apparatus according to claim 1.
